(19) United States
(12) Patent Application Publication
(10) Pub. No.: US 2012/0160752 A1
(43) Pub. Date: Jun. 28, 2012

(54) OXIDATION POND INCLUDING BAFFLES FOR TREATING ACID MINE DRAINAGE

(75) Inventors: Dong-Kil LEE, Daejeon (KR); Gil-Jae YIM, Daejeon (KR); Sang-Woo JI, Daejeon (KR); Young-Wook CHEONG, Daejeon (KR)

(73) Assignee: KOREA INSTITUTE OF GEOSCIENCE AND MINERAL RESOURCES(KIGAM), Daejeon (KR)

(21) Appl. No.: 13/021,808

(22) Filed: Feb. 7, 2011

(30) Foreign Application Priority Data
Dec. 24, 2010 (KR) 10-2010-0134454

(51) Int. Cl. C02F 1/72; C02F 7/00; C02F 1/52

(52) U.S. Cl. 210/170.09

(57) ABSTRACT

Provided is an oxidation pond for treating acid mine drainage discharged from an abandoned mine. The oxidation pond comprises: an inlet into which mine drainage is introduced; a retention pond in which the mine drainage introduced into the inlet resides; and an outlet through which the mine drainage is discharged from the retention pond, so that iron in the mine drainage is oxidized and precipitated during residence of the mine drainage in the retention pond, wherein a neutralizing agent that increases the pH of the mine drainage to accelerate the iron precipitation reaction is placed in the retention pond.

### CROSS-REFERENCE TO RELATED APPLICATION

This application claims priority to and the benefit of Korean Patent Application No. 10-2010-0134454 filed on 24 Dec. 2010, the disclosure of which is incorporated herein by reference in its entirety.

### BACKGROUND OF THE INVENTION

1. Field of the Invention

The present invention relates to technology for reducing environmental pollution, and more particularly, to an oxidation pond which is used in a passive treatment method for acid mine drainage discharged from abandoned mines or the like.

2. Description of Related Art

An oxidation pond is used in a passive treatment method for treating acid mine drainage (AMD). In the oxidation pond, mine drainage resides for a given time during which ferrous iron contained in the mine drainage precipitates as iron oxide by an oxidation reaction with oxygen.

The most important factor in designing the oxidation pond is the retention time of mine drainage which should generally be at least 48 hours. In design conditions of the oxidation pond, the inflow conditions of mine drainage are determined based on the area that comes in contact with oxygen. Namely, the oxidation pond is designed based on the nominal retention time obtained by dividing the total volume of the oxidation pond by the inflow rate of mine drainage, assuming that the flow rate of the mine drainage is 1 L/sec per 100 m² of the contact area.

The size and shape of most oxidation ponds vary depending on their locations and land costs, but it is general that the internal structure of the oxidation pond is completely filled with mine drainage without any structure. This appearance of the oxidation pound is the same worldwide.

The flow pattern of mine drainage that flows into the oxidation pond varies depending on the inlet and outlet sizes and shapes of the oxidation pond, the flow rate of mine drainage, etc. In order to visually understand this flow pattern, it is useful to use a method of analyzing the flow pattern on the basis of the flow paths and characteristics included in mine drainage that flows into the inlet.

The present inventors evaluated a conventional oxidation pond. Specifically, the flow pattern of the conventional oxidation pond was examined using edible dye Blue No. 2 harmless to the human body, brine was used to calculate the retention time of mine drainage, and a CTD-Diver was used to measure electrical conductivity. In the measurement method, a tracer (brine) was introduced into an inlet for mine drainage in order to measure retention time that is the time taken for mine drainage to reach the outlet, and the range of diffusion of the dye during the time.

The oxidation pond used in the experiment was a Sukbong oxidation pond located at Mungyeong-shi, Gyeongsangbuk-do, Korea, which had an octagonal shape, a size of 14 m (width)×6 m (length), and a total depth of 1.5 m. Considering that the thickness of the precipitate at the bottom of the oxidation pond is 0.35 m at present and that the height from the top of the oxidation pond to the surface of the water is 0.4 m at present, the average depth of the oxidation pond at the time of the measurement is about 0.75 m. The inlet into which mine drainage flows is composed of a pipe having an inner diameter of 40 cm, and the level of water in the pipe is about 0.15 m away from the bottom of the pipe. The outlet is composed of a rectangular concrete conduit having a width of 0.4 m and a height of 0.5 m. The flow rate of mine drainage which flows into the oxidation pond is 86.4 m³/hr.

Edible dye Blue No. 2 was injected into the inlet of the Sukbong oxidation pond at a given concentration, and the diffusion path of the dye with time was examined. After the injection, the dye showed a straight flow pattern connecting the inlet with the outlet, and little or no portion of the dye flowed to the surrounding area. A portion of the dye showed a tendency to flow to the surrounding area, but this movement is regarded as diffusion caused by the difference in concentration. The time taken for the dye to reach the outlet after injection was measured to be 95 seconds.

Also, the time taken for brine introduced into the inlet of the oxidation pond to reach the outlet to show the change in electrical conductivity was measured to be 261 seconds after the introduction of brine into the inlet, and the time taken for electrical conductivity in the outlet to become constant was measured to be 295 seconds after the introduction of brine. Accordingly, the time taken for brine to be sensed at the outlet was 4.35 minutes after the introduction of brine.

Meanwhile, computational flow analysis was performed in order to understand the flow characteristics of mine drainage that flows into the Sukbong oxidation pond. As a result, in the plane of the Sukbong oxidation pond, a line connecting the inlet to the outlet showed the highest flow rate, and in the longitudinal section of the Sukbong oxidation pond, the flow rate gradually increased toward the outlet. However, it was shown that portions having a high flow rate were located mainly at the surface of the water.

Also, when examining the flow pattern of mine drainage in the Sukbong oxidation pond, the mine drainage flowed along a straight line, connecting the inlet to the outlet, at a high rate, and was discharged to the outlet, but a vortex flow was formed at both sides of the straight line, indicating that there was a region in which the mine drainage was only circulated between the inlet and the outlet without being discharged.

Moreover, the retention time of mine drainage in the Sukbong oxidation pond was measured. As a result, mine drainage flowing along the straight line connecting the inlet to the outlet showed a very short retention time, whereas mine drainage placed surrounding the straight line showed a long retention time. Namely, it is concluded that regions other than the above straight line region are not regions through which mine drainage flows, but regions in which mine drainage stagnates.

When examining the retention time distribution in the longitudinal section of the Sukbong oxidation pond, it was shown that the retention time was significantly longer in the lower portion than the upper portion.

In summary, it can be seen that the main flow region in the oxidation pond is the straight line region connecting the inlet to the outlet and also that, in the process in which mine drainage flows in and out of the oxidation pond, there is little or no flow in the deep portion of the oxidation pond, and mine drainage mostly flows along the water surface.

As a result, it can be seen that the oxidation pond is divided into a main flow region, which connects the inlet to the outlet, and a stagnation region, and that mine drainage introduced into the oxidation pond flows along the main flow region, and the remaining region is a stagnation region which does not participate in the flow of the mine drainage.

Namely, the introduced mine drainage flows along a specific flow region without flowing throughout the oxidation pond. Thus, mine drainage that is flows from the inlet directly to the outlet through the main flow region of the oxidation pond has a very short retention time in the oxidation pond. Also, the space of the oxidation pond is not efficiently used due to the stagnation region of the oxidation pond, and thus the function of the oxidation pond cannot be sufficiently performed.

Particularly, if the retention time of mine drainage in the oxidation pond is short as described above, there is a problem in that the precipitation of ferrous iron by sufficient contact with oxygen is reduced, thus making the subsequent treatment of the mine drainage difficult.

Meanwhile, the rate of a reaction in which iron ions in mine drainage are oxidized by oxygen to precipitate as hydroxides has a deep relationship with the pH of the mine drainage. FIG. 1 is a graphic diagram showing the change in the rate of an iron precipitation reaction according to the change in pH. As can be seen from the graph of FIG. 1, the reaction rate rapidly increases as the pH rises from about 3 toward a neutral pH.

Accordingly, there is a need to develop a specific technology that can increase the retention time of mine drainage in an oxidation pond at, at the same time, accelerate the precipitation of iron in mine drainage using the change in pH.

### SUMMARY OF THE INVENTION

The present invention has been made in order to solve the above-described problems occurring in the prior art, and it is an object of the present invention to provide an oxidation pond which has an improved structure such that mine drainage can be widely diffused over the entire region of the oxidation pond after the introduction thereof to increase the retention time of the mine drainage, thus increasing the efficiency of precipitation and removal of iron in the mine drainage, and also such that a stagnation region does not occur.

According to one aspect of the present invention, there is provided an oxidation pond for treating mine drainage, comprising: an inlet into which mine drainage is introduced; a retention pond in which the mine drainage introduced into the inlet resides; and an outlet through which the mine drainage is discharged from the retention pond, so that iron in the mine drainage is oxidized and precipitated during retention of the mine drainage in the retention pond, wherein the oxidation pond comprises a plurality of main baffles which are formed in a direction crossing a direct direction connecting the inlet to the outlet and are arranged spaced from each other between the inlet and the outlet, so that the mine drainage introduced through the inlet into the retention pond can flow along the retention pond in a zigzag fashion and can be discharged to the outlet.

Also, the oxidation pond of the present invention further comprises a plurality of auxiliary baffles which are formed in a direction crossing the main baffles and are arranged spaced from each other, so that the mine drainage that flows in a zigzag fashion in a planar direction due to the plurality of main baffles can flow along a vertical direction in a zigzag direction.

Also, the oxidation pond of claim 3, wherein the plurality of auxiliary baffles are movable upward and downward.

In the present invention, a neutralizing agent comprising limestone may be placed in the retention pond to increase the pH of the mine drainage.

In one embodiment, at least one of the main baffles, the auxiliary baffles and the wall surface of the retention pond is prepared to comprise limestone and can act as a neutralizing agent, wherein the neutralizing agent may be framed of a natural limestone mass.

Also, the neutralizing agent comprises limestone fine powders and a binder forming the limestone fine powders into one mass, wherein the binder is dissolved in the mine drainage while the limestone fine powders come in contact with the mine drainage.

Also, the neutralizing agent may be formed of a limestone mass having a number of cracks formed by pressing.

Also, the neutralizing agent is preferably suspended in water of the oxidization pond.

Also, the neutralizing agent is preferably disposed closer to the inlet than the outlet and suspended in water of the retention pond.

### BRIEF DESCRIPTION OF THE DRAWINGS

The above and other objects, features and advantages of the present invention will become more apparent to those of ordinary skill in the art by describing in detail preferred embodiments thereof with reference to the attached drawings in which:

FIG. 1 is a graphic diagram showing the change in the rate of an iron precipitation reaction according to the change in pH;

FIG. 2 is a schematic plan view of an oxidation pond for treating mine drainage according to a first embodiment of the present invention;

FIG. 3 is a schematic cross-sectional view taken along line III-III of FIG. 2;

FIG. 4 is a schematic cross-sectional view taken along line IV-IV of FIG. 2;

FIG. 5 is a schematic view illustrating a second embodiment of the present invention;

FIG. 6 is a schematic view illustrating a third embodiment of the present invention;

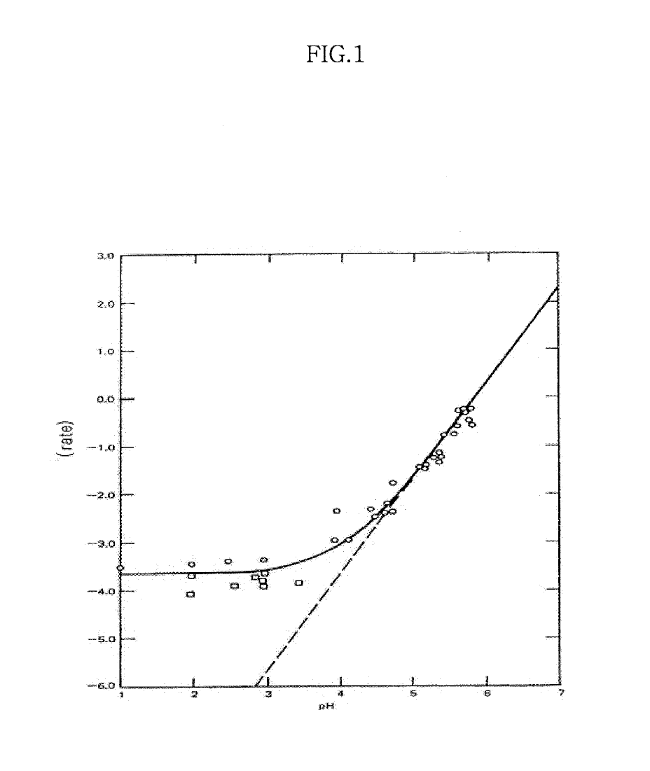

### DETAILED DESCRIPTION OF THE INVENTION

First, acid mine drainage (AMD) to be treated using an oxidation pond according to the present invention will be briefly described. Acid mine drainage is formed when sulfide minerals, including pyrite (FeS₂) and marcasite (FeS), exposed to the atmosphere, are oxidized by a reaction with oxygen and water. It is characterized in that it has an acidic pH and high contents of sulfates and metals, including iron, aluminum and manganese.

The oxidation reaction of pyrite is expressed by the following equations:

FeS₂+ 7/2O₂+H₂O→Fe²⁺+2SO4²⁻+2H⁺

Fe²⁺+¼O₂+H⁺→Fe³⁺+½H₂O

Fe³⁺+3H₂O→Fe(OH)₃(s)+3H⁺

FeS₂+Fe³⁺+8H₂O→15Fe²⁺+2SO4²⁻+16H⁺

As shown in the above equations, pyrite is oxidized to generate iron ions and sulfate ions and becomes acidic due to hydrogen ions. Such acid mine drainage is formed at a low pH so that heavy metals are easily dissolved in the acid mine drainage and move together with the acid mine drainage. The heavy metals that moved together with the acid mine drainage contaminate the surrounding surface water and underground water to destroy the aquatic ecosystem. Also, the metal ions are oxidized and precipitated as metal hydroxides such as Fe(OH)₃, which generate red brown or white precipitates (called “yellow boy”) at the river bottom to injure the appearance.

In a passive treatment method for mine drainage, an oxidation pond is provided at the entrance of an abandoned mine from which acid mine discharge is discharged, so that iron is precipitated from the acid mine drainage.

Ferrous ions are oxidized to precipitate in the form of hydroxides as shown in the following equation:

4Fe²⁺+O₂+4H⁺→4Fe³⁺+2H₂O

Fe³⁺+3H₂O→Fe(OH)₃(s)+3H⁺

As shown in the equation above, in order for iron ions in mine drainage to precipitate as hydroxides, the iron ions must react either with oxygen in the air or with dissolved oxygen in the mine drainage.

However, as described in Background of the Invention above, if the retention time of mine drainage in the oxidation pond is short, a sufficient reaction will not occur so that a large amount of iron ions can be contained in mine drainage that is discharged from the oxidation pond. If the mine drainage is subsequently treated in a state in which iron was not removed therefrom, various problems will arise.

For example, in a successive alkalinity-producing system (SAPS), mine drainage passes through an organic layer and a limestone layer after passing through an oxidation pond, and iron ions which were not precipitated in the oxidation pond are precipitated in the limestone layer, thus causing the problem of reducing the permeability of the limestone layer.

The present invention provides an oxidation pond in which mine drainage resides for a sufficient time such that a sufficient iron precipitation reaction between iron ions and oxygen in mine drainage can occur.

Hereinafter, an oxidation pond for treating mine drainage according to an embodiment of the present invention will be described in further detail with reference to the accompanying drawings.

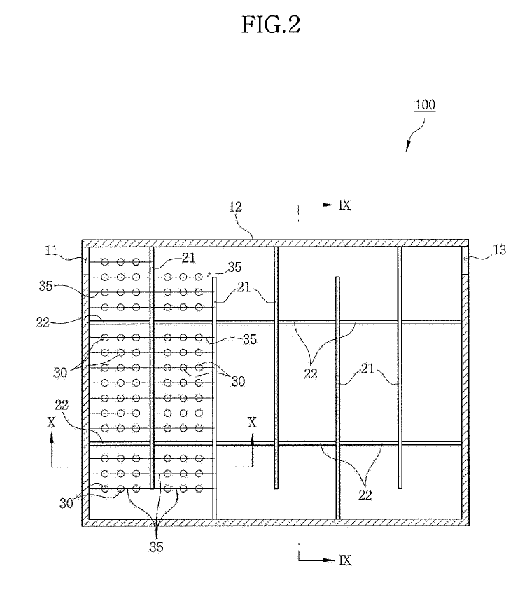

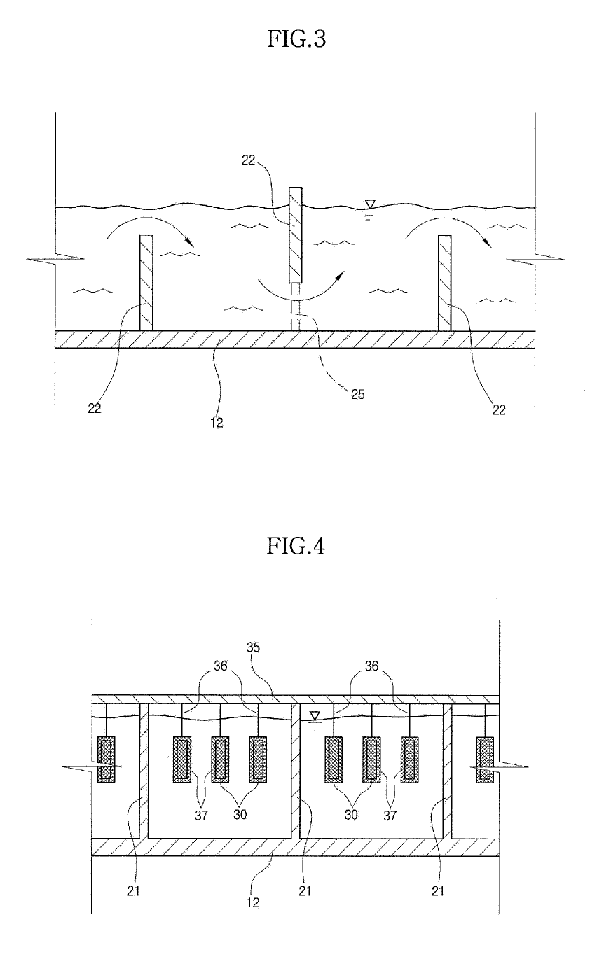

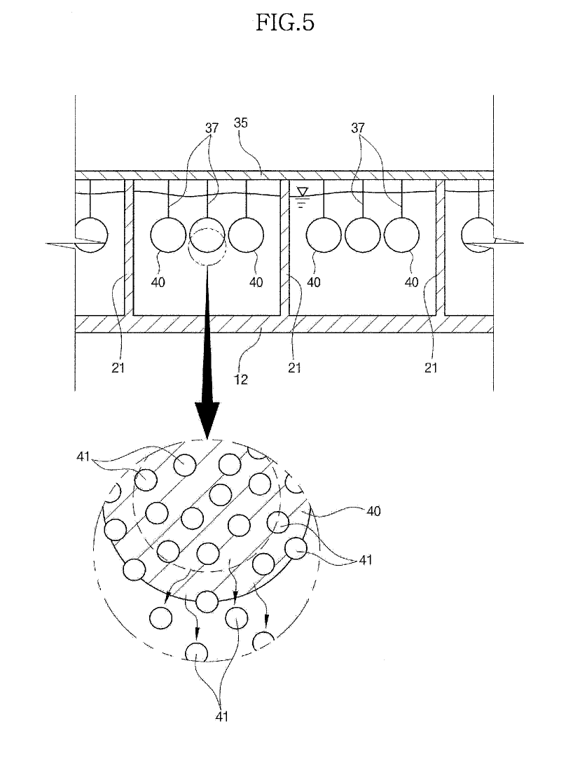

FIG. 2 is a schematic plan view of an oxidation pond for treating mine drainage according to a first embodiment of the present invention; FIG. 3 is a schematic cross-sectional view taken along line III-III of FIG. 2; and FIG. 4 is a schematic cross-sectional view taken along line IV-IV of FIG. 2.

Referring to FIGS. 2 to 4, the oxidation pond for treating mine drainage is a kind of retention pond which is disposed adjacent to an abandoned mine or the like to temporarily receive mine drainage from the abandoned mine while precipitating iron from the mine drainage. Accordingly, an oxidation pond 100 according to the present invention comprises: an inlet 11 into which mine drainage flows; a retention pond 12 in which the mine drainage resides; and an outlet 13 through which the mine drainage is discharged.

A naturally formed pond is generally used as the retention pond, but a pond formed by forming outer walls in consideration of geographical conditions may also be used as the retention pond.

In the present invention, a plurality of main baffles are formed in the retention pond 12 such that the mine drainage introduced through the inlet 11 can be discharged to the outlet 13 while forming a zigzag type flow in the retention pond. This is because, if the mine drainage flows in a zigzag fashion, it can pass through the entire region of the retention pond 12, thus increasing the retention time.

The main baffles 21 have a plate shape and are placed in the retention pond in the direction crossing the direct direction that connects between the inlet 11 and the outlet 13. In this embodiment, the main baffles are placed perpendicular to the direct direction.

However, the main baffles 21 do not need to necessarily be placed perpendicular to the direct direction, and they may be placed in consideration of the arrangement state of the inlet 11 and the outlet 13 in the retention pond, the main flow direction of mine drainage, and the flow rate and pH of mine drainage, such that the retention time allowing a sufficient iron precipitation reaction to occur in mine drainage can be ensured. For example, the pH of mine drainage is low, the rate of the precipitation rate will be reduced, and thus the retention time should be increased, and if the pH is high, the rate of the precipitation will be increased, and thus the retention time can be relatively shortened.

The main baffles 21 are arranged in such a manner that they come into contact with one sidewall and the opposite sidewall in an alternate manner. For example, one end of the main baffles odd-numbered from the inlet 11 comes into contact with one sidewall of the retention pond, and the other end is disposed spaced from the opposite sidewall of the retention pond, so that mine drainage flows between the other end of the main baffles 21 and the opposite sidewall of the retention pond 12. Conversely, one end of the main baffles even-numbered from the inlet 11 is spaced from one sidewall of the retention pond 12, and the other end comes into contact with the other sidewall of retention pond 12, so that mine drainage flows between one end of the main baffles 21 and one sidewall of the retention pond 12. Also, in order to prevent mine drainage from overflowing, the height of the main baffles 21 is preferably higher than the water surface of the retention pond 12.

As a result, mine drainage flows between the main baffles 21, while they form a flow in a zigzag fashion when viewed in the entire plan of the retention pond 12. Accordingly, the retention time of mine drainage in the retention pond 12 is increased.

Meanwhile, as described above, mine drainage flows through the entire region of the retention pond 12 when viewed in the plane of the retention pond 12, but allowing mine drainage to flow upward and downward using the main baffles 21 only is limited. Accordingly, in this embodiment, a plurality of auxiliary baffles 22 are placed in the retention pond 12 to solve the problem in that mine drainage flows only through the water surface in the conventional oxidation pond, whereby mine drainage flows upward and downward in a zigzag fashion in the retention pond 12.

The auxiliary baffles 22 have a plate shape and are placed between the main baffles 21 in a direction perpendicular to the main baffles 21. A structure that supports the auxiliary baffles 21 in the retention pond 12 can be configured in various manners, and in this embodiment, the auxiliary baffles 21 are supported by support rods 25.

Namely, the support rods 25 are formed in a vertical direction and inserted into the bottom of the retention pond 12. Also, the auxiliary baffles 22 are inserted into the support rods 25 in such a manner that they can ascend and descend. Namely, although not shown, a long groove is formed in the auxiliary baffles 22, and the support rod 25 is inserted into the groove, so that the auxiliary baffles can slide along the support rods 25. Thus, the height of each auxiliary baffle 22 can be controlled.

The plurality of auxiliary baffles 22 are arranged at the upper and lower portions of the retention pond in an alternate manner. Namely, the lower end of the auxiliary baffles 22 arranged at the lower portion of the retention pond 12 comes into contact with the bottom of the retention pond 12. Because the height of the auxiliary baffles 22 is lower than the water level of the retention pond 12, mine drainage can flow above the auxiliary baffles 22. Also, the upper end of the auxiliary baffles 22 disposed at the upper portion of the retention pond 12 is higher than the water surface of the retention pond 12, and the lower end is spaced upward from the bottom of the retention pond 12. Thus, mine drainage passes through the auxiliary baffles 22 arranged at the upper and lower portions of the retention pond in an alternate manner while it flows upward and downward.

As described above, in the present invention, the mine drainage introduced into the inlet 11 is discharged to the outlet 13 while it flows in a zigzag fashion using the main baffles 21 and the auxiliary baffles 22 and flows upward and downward, so that the hydraulic retention time of the mine drainage is increased. Also, because the entire region of the retention pond 12 participates in the flow of mine drainage, an stagnation region is eliminated, thus increasing the efficiency of the retention pond 12.

The applicant carried out an experiment on the performance of the case in which the main baffles 21 and the auxiliary baffles 22 were placed.

In order to verify the performance of the present invention, a tracer experiment and computational flow analysis were first carried out to prove the validity of the results of computational analysis. Then, the experimental results were used in examples of the present invention to examine the increase in the retention time of mine drainage and the effect resulting from the increase in the retention time.

The flow pattern and retention time of mine drainage that flows into the oxidation pond vary depending on the inlet and outlet sizes and shapes of the oxidation pond, the flow rate of the mine drainage, etc. In order to visually examine the flow pattern, an experiment was carried out using a method of adding tracers to mine drainage that flows in the inlet and analyzing the flow path and characteristics of the tracers. As the tracers, edible dye Blue No. 2 harmless to the human body was used to examine the flow pattern, and salt was used to measure the retention time. Also, a CTD-Diver was used to measure the electrical conductivity at the inlet and the outlet.

In this experiment, a Hwangji-Yuchange oxidation pond located at Mungyeong-shi, Gyeongsangbuk-do, Korea was used which had a size of 46 m×8.7 m and a right-angled triangular shape. Also, the oxidation pond was constructed to have a depth of 1 m, but the actual depth of the oxidation pond is about 0.35 m, considering that the height of a precipitate on the bottom is about 0.3 m and the height from the top of the oxidation pond to the water surface is about 0.35 m.

The inlet of the oxidation pond is composed of a pipe having an inner diameter of 0.6 m, and mine drainage is discharged from the tube and dropped and introduced into the oxidation pond. Also, the outlet is disposed at the bottom of the oxidation pond and has a size of about 0.5×0.2 m. The flow rate of mine drainage that flows into the oxidation pond is 59.3 m³/hr.

First, in a state in which main baffles and auxiliary baffles were not placed, the flow characteristics of the oxidation pond were examined through computational analysis and actual experimentation, and whether the results of the computational analysis were consistent with the results of the actual experimentation was confirmed. If the results of the computational analysis are similar to the results of the actual experimentation, the reliability of the computational analysis can be reliable.

Edible dye Blur No. 2 was injected into the inlet at a constant concentration for 4 minutes, and the influences of flow and diffusion with time were examined. At the initial stage of injection of the dye (passage of 40 minutes), the dye was distributed mainly at the sidewall connecting the inlet to the outlet, and with the passage of time to 80 minutes and 140 minutes, the dye showed a tendency to be gradually diffused toward the right side of the inlet. This tendency likewise appeared in the results of computational analysis. In the results of computational analysis, it can be seen that, with the passage of time, the region of the retention time extended gradually toward the right side of the inlet. The range of diffusion of the dye, obtained by the actual experimentation, was relatively well consistent with the range of diffusion of the dye, obtained by the computational analysis.

Meanwhile, a rapid change in electrical conductivity at the inlet of the oxidation pond by salt was first sensed 12 minutes after the injection of the tracer (salt), and the time at which a rapid change in electrical conductivity at the outlet was first sensed was 34 minutes after the injection of the tracer. Thus, the time taken for the tracer to reach the outlet after injection of the tracer was 22 minutes. This likewise appeared in the results of the computational analysis.

The results of the actual experimentation and the results of the computational analysis showed a slight difference of about 2-3 minutes. Actual experimentation is carried out at a site, site conditions, including the effect of wind at the site and the shape of a precipitate layer in water, are reflected, but such conditions cannot be accurately considered in computational analysis, and some errors cannot be avoided. Due to these effects, the computational analysis results show slightly faster values than those of the experimental results, but it can be regarded that these values are similar.

As described above, the computational analysis results were similar to the experimental results with respect to the flow pattern and retention time of mine drainage with time, and thus the relatively reasonable analysis of the present invention is possible through computational analysis. Namely, the reliability of computational analysis can be admitted.

After confirming the reliability of computational analysis, the performance of the present invention was examined by computational analysis.

In order to evaluate the performance of an oxidation pond according to one embodiment of the present invention, computational analysis was performed for a total of 3 cases: a case in which no baffle was placed; a case in which only main baffles were placed; and a case in which all main baffles and auxiliary baffles were placed.

The size of an oxidation pond was set at 1.45 m×1.45 m×0.3 m, and the flow rate of mine drainage was set at 1.26 l/min. Also, 4 main baffles were placed in the oxidation pond, so that mine drainage introduced into the inlet would flow in a zigzag fashion when viewed in the plane of the retention pond and was discharged to the outlet. Also, between the main baffles, 2 auxiliary baffles were placed at the upper and lower portions of the oxidation pond, respectively, so that the mine drainage would flow upward and downward.

Computational analysis was carried out. As a result, in the case in which no baffle was placed, the flow of mine drainage appeared as a main flow region connecting the inlet to the outlet, and as stagnation regions at the left and right sides of the main flow region, and the mine drainage in the oxidation pond showed a non-uniform rate distribution and retention time distribution. On the other hand, in the case in which the main baffles were placed, the mine drainage flowed in a zigzag fashion due to the baffles while flowing along the entire region of the oxidation pond. Particularly, the case in which the main baffles together with the auxiliary baffles were placed showed a more uniform flow compared to the case in which only the main baffles were placed.

First, when seeing the rate distribution obtained by computational analysis, in the case in which no baffle was placed, the mine drainage flowed at a high rate in a straight line region connecting the inlet to the outlet, and it showed a low flow rate at the left and right sides of the straight line region. However, in the case in which the main baffles were placed, the flow rate of the mine drainage discharged from the inlet was reduced due to the baffles, and then maintained at a constant level on the water surface while it flowed to the outlet.

Also, when seeing the flow line distribution, in the case in which no baffle was placed, a main flow occurred in a straight line region connecting the inlet to the outlet, and the mine drainage swirled due to a vortex flow at the left and right sides of the straight line region in the oxidation pond. On the other hand, in the case in which the baffles were placed, the mine drainage discharged from the inlet collided with the baffles to form a turbulent flow, making the flow rate distribution constant, and moved along a path formed by the baffles.

Also, when seeing the results of computational analysis for the retention time distribution, in the case in which a straight line region connecting the inlet to the outlet showed a short retention time, the left and right sides of the straight line region showed a stagnation region indicating a long retention time, and thus a non-uniform retention time distribution was shown. However, in the case in which the baffles were placed, a uniform and long retention time throughout the oxidation pond was shown.

Particularly, in the case in which only the main baffles were placed, some stagnation regions appeared due to a vortex flow at a place where the flow direction turned at an angle of 180°. However, in the case in which the main baffles together with the auxiliary baffles were placed, a relatively long retention time was shown due to a local vortex flow at a place where the flow direction turned at an angle of 180°, but no stagnation region occurred.

As described above, it can be seen that the oxidation pond according to the present invention is very effective in improving the retention time of mine drainage.

The retention time obtained from computational analysis conducted to evaluate performance for each case is shown in Table 1 below. The reason why the nominal retention time in Table 1 differs between the cases is that the volumes of baffles placed in each case were considered.

TABLE 1

| | | | | Case 2/ | Case3/ | Case 3/ |
|---|---|---|---|---|---|---|
| Physical properties | Case 1 | Case 2 | Case 3 | case 1 | case 1 | case 2 |
| Nominal retention | 500 | 476 | 467.2 | 1.0 | 0.9 | 1.0 |
| time | | | | | | |
| N (min) | | | | | | |
| First arrival time | 1.2 | 324.3 | 432.4 | 270.3 | 360.3 | 1.3 |
| M (min) | | | | | | |
| Average retention | | | | | | |
| time | 406.0 | 478.4 | 466.9 | 1.2 | 1.1 | 1.0 |
| A (min) | | | | | | |
| Volume average | 0.0014 | 0.0005 | 0.0005 | 0.4 | 0.4 | 1.0 |
| velocity V (m/sec) | | | | | | |
| Volume average | 1729.7 | 312.4 | 282.5 | 0.2 | 0.2 | 0.9 |
| retention time (min) | | | | | | |
| M/N(%) | 0.2 | 68.1 | 92.6 | 340.5 | 463.0 | 1.4 |
| A/N(%) | 81.2 | 100.5 | 99.9 | 1.2 | 1.2 | 1.0 |
| Exchange efficiency | 14.5 | 76.2 | 82.7 | 5.3 | 5.7 | 1.1 |
| (%) | | | | | | |

When seeing the first arrival time that is the time taken for mine drainage to reach the outlet from the inlet, the first arrival time was 1.2 minutes in the oxidation pond of case 1 in which no baffle was placed. This is because the mine drainage introduced into the oxidation pond moved along the water surface of the main flow region.

On the other hand, in case 2 in which the main baffles were placed and in case 3 in which the main baffles together with the auxiliary baffles were placed, the first arrival times were 324.3 minutes and 432.4 minutes, respectively, which were about 270-360 times longer than that of case 1. Particularly, the case in which the main baffles and the auxiliary baffles were placed, the first arrival time was increased by at least 100 minutes compared to the case in which only the main baffles were present.

The ratio of the average retention time to the nominal retention time reached 81.2% in case 1, whereas it reached about 100% in case 2 and case 3, indicating a long retention time. Also, the ratio of the first arrival time to the nominal retention time was as extremely low as 0.2% in case 1 and was 68.1% and 92.6% in case 2 and case 3, respectively, suggesting that the overall retention time distribution rapidly increased in the case in which the baffles were placed, and also suggesting that the retention time distribution was about 1.4-times more uniform in the case in which the main baffles together with the auxiliary baffles were present than in the case in which only the main baffles were present.

The exchange efficiency of mine drainage was as low as 14.5% in case 1, whereas it was increased to 76.2% in the case in which the main baffles were placed, and it was significantly increased to 82.7% in the case in which the main baffles together with the auxiliary baffles were placed.

Accordingly, in the case in which the baffles were placed, particularly in the case in which the main baffles together with the auxiliary baffles were placed, the flow distribution of mine drainage becomes uniform, the first arrival time was at least 360 times increased, and the exchange efficiency of mine drainage was also significantly increased from 14.5% to 82.7%, compared to the oxidation pond in which no baffle was placed.

As described above, in the present invention, the main baffles and the auxiliary baffles are placed in the oxidation pond, whereby mine drainage can flow throughout the oxidation pond.

As the retention time of mine drainage in the oxidation pond increases as described above, the mine drainage can react with oxygen for a sufficient time, so that iron ions in the mine drainage can be precipitated at the bottom of the oxidation pond and removed.

The foregoing description has been made on the structure that allows the retention time of mine drainage in the oxidation pond can be sufficiently guaranteed so that iron ions in the mine drainage are oxidized to precipitate as hydroxides.

Meanwhile, the iron precipitation reaction in mine drainage has a deep relationship not only with the contact time with oxygen, but also with the pH of the mine drainage. Accordingly, in the present invention, the pH of mine drainage is increased to accelerate the iron precipitation reaction.

Namely, limestone is introduced into the retention pond 12 to increase the pH of mine drainage, thereby accelerating the iron precipitation reaction.

In conventional treatment systems such as SAPS, a limestone layer was formed at the bottom of the retention pond so that mine drainage passes through the limestone layer downward. However, in the structure of SAPS, iron hydroxide that precipitated from mine drainage is coated on the limestone layer or fills the pores of the limestone, such that mine drainage could not flow through the limestone layer. Particularly, if iron oxide is coated on the surface of limestone, the limestone cannot no longer as a neutralizing agent.

In order to solve this problem, in the present invention, a neutralizing agent 30 is used in such a manner that it is suspended in the water of the retention pond 12. Namely, if the neutralizing agent is suspended in water, the neutralizing agent can be prevented from being coated with iron hydroxide, due to flow rate. The neutralizing agent 30 of limestone can be suspended in water in various manners. In this embodiment, a support 35 is placed on the main baffles 21, and a connection element 36 (e.g., a rope) from which a net bag 37 is hung is suspended on the support 35. Also, the limestone neutralizing agent 30 is placed in the net bag 37, so that mine drainage comes into contact with the limestone neutralizing agent 30 while it flows. Of course, the limestone neutralizing agent may also be connected directly to the connection element without using a structure such as the net bag.

Also, the neutralizing agent 30 may be configured in various forms. In the first embodiment shown in FIG. 4, a natural limestone mass is used.

When selecting the form of the neutralizing agent 30, two considerations should be taken into account: whether coating of the neutralizing agent with iron hydroxide is effectively prevented; and whether neutralization can be smoothly achieved by enlarging the contact area with mine drainage.

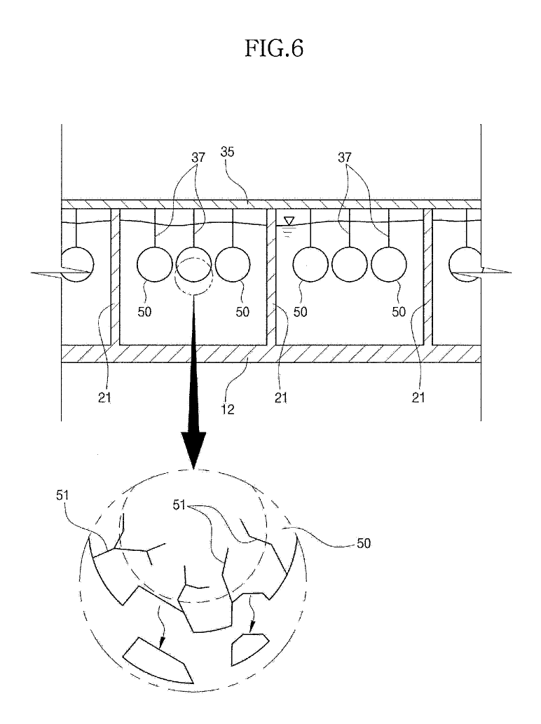

Accordingly, in the neutralizing agents 40 and 50 used in the second embodiment shown in FIG. 5 and the third embodiment shown in FIG. 6, the above two considerations are taken into account.

Specifically, referring to FIG. 5, the neutralizing agent 40 used in the second embodiment is prepared by grinding limestone to form fine powers 41 and forming the fine powders into a mass using a binder 42. As the binder 42, a material that can be dissolved in mine drainage at a constant rate with the passage of time is selected. For example, the material can be polyethylene-vinylacetate (EVA), hydrogel, cellulose acetate silicone rubber, polyurethane and silicone matrix that are also used as a release control agent (RCA) of drug delivery system (DDS). Because the binder 42 is dissolved at a constant rate, the neutralizing agent 40 is not coated with iron hydroxide, and the limestone fine powders 41 are released into mine drainage by the dissolution of the binder 42, wherein the fine powders have a significantly large surface area compared to a limestone mass having the same volume, and thus can rapidly increase the pH of mine drainage.

Namely, as shown by the dotted line in FIG. 5, while the binder 42 is dissolved up to the dotted line, the fine powders 41 that adhered to the dissolved binder are introduced into mine drainage to increase the pH of the mine drainage. The fine powder 41 may be supplied to mine drainage in a given amount with the passage of time until the binder is completely dissolved. Namely, if only the fine powders 41 are placed on the net bag without the binder, the fine powders will be too rapidly introduced into mine drainage, such that they cannot serve to increase the pH of mine drainage for a given period of time.

Also, referring to FIG. 6, the neutralizing agent 50 used in the third embodiment is prepared by pressing a limestone mass to form fine cracks 51. More specifically, the limestone mass is pressed with a three-axial (X-axis, Y-axis and Z-axis) compressor to form cracks. If the limestone having fine cracks 51 is suspended in the retention pond 12, mine drainage will be introduced into the fine cracks 51 so that small limestone pieces will be separated. This can solve the problem in which iron hydroxide is coated on the surface of the limestone, and the fine limestone pieces can be introduced into mine drainage while they can effectively increase the pH of the mine drainage.

Also, the limestone neutralizing agents 30, 40 and 50 used in the first to third embodiments are disposed close to the inlet 11 in the retention pond 12. The portion close to the inlet 11 has a relatively fast flow rate, so that the neutralizing agent is prevented from being coated with iron hydroxide. Moreover, because iron ions have a tendency to precipitate rapidly when they meet iron ions, increasing the pH of mine drainage at the inlet where the mine drainage first comes into contact with oxygen is effective for iron precipitation.

Meanwhile, in other embodiments of the present invention, the main baffles 21 or the auxiliary baffles 22 may also be made of limestone so as to act as a neutralizing agent, without placing a separate neutralizing agent as described above. Also, the outer wall of the retention pond 12 may be made of limestone.

As described above, in the present invention, the main baffles 21 and the auxiliary baffles 22 are used so that mine drainage can reside in the retention pond for a sufficient time. Also, the neutralizing agent is used to increase the pH of mine drainage, so that most iron ions in the mine drainage can be precipitated.

Also, in the present invention, the baffles are used so that mine drainage can reside in the retention pond for a sufficient time so as to react with oxygen for a sufficient time, thus increasing the efficiency of precipitation of iron ions in the mine drainage.

In addition, in one embodiment of the present invention, the neutralizing agent is used to increase the pH of mine drainage so as to increase the efficiency of precipitation of iron ions in the mine drainage, thus facilitating the subsequent treatment of the mine drainage.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An oxidation pond for treating acid mine drainage, comprising: an inlet into which the mine drainage is introduced; a retention pond in which the mine drainage introduced into the inlet resides; and an outlet through which the mine drainage is discharged from the retention pond, so that iron in the mine drainage is oxidized and precipitated during retention of the mine drainage in the retention pond, wherein the oxidation pond comprises a plurality of main baffles which are formed in a direction crossing a direct direction connecting the inlet to the outlet and are arranged spaced from each other between the inlet and the outlet, so that the mine drainage introduced through the inlet into the retention pond can flow along the retention pond in a zigzag fashion and can be discharged to the outlet.

2. The oxidation pond of claim 1, wherein the plurality of main baffles are arranged such that they come in contact with one side of the retention pond and the opposite side of the retention pond in an alternate manner.

3. The oxidation pond of claim 1, wherein the oxidation pond further comprises a plurality of auxiliary baffles which are formed in a direction crossing the main baffles and are arranged spaced from each other, so that the mine drainage that flows in a zigzag fashion in a planar direction due to the plurality of main baffles can flow along a vertical direction in a zigzag direction.

4. The oxidation pond of claim 3, wherein the plurality of auxiliary baffles consist of: first auxiliary baffles whose lower end is disposed spaced from the bottom of the retention pond and whose upper end is disposed above the water surface of the retention pond; and second auxiliary baffles whose lower end is disposed in contact with the bottom of the retention pond and whose upper end is immersed in the retention pond, wherein the first auxiliary baffles and the second auxiliary baffles are alternately arranged.

5. The oxidation pond of claim 3, wherein the plurality of auxiliary baffles are movable upward and downward.

6. The oxidation pond of claim 5, wherein the oxidation pond further comprises support rods are vertically placed at the bottom of the retention pond and into which the auxiliary baffles are inserted such that they are slidable upward and downward.

7. The oxidation pond of claim 1, wherein a neutralizing agent comprising limestone is placed in the retention pond to increase the pH of the mine drainage.

8. The oxidation pond of claim 7, wherein the oxidation pond further comprises a plurality of auxiliary baffles which are placed in a direction crossing the main baffles and are arranged spaced from each other, such that the mine drainage that flows in a zigzag fashion in a planar direction due to the plurality of main baffles can flow upward and downward in a zigzag fashion, wherein at least one of the main baffles and the auxiliary baffles is prepared to comprise limestone and acts as a neutralizing agent.

9. The oxidation pond of claim 7, wherein an outer wall forming the retention pond is prepared to comprise limestone and acts as a neutralizing agent.

10. The oxidation pond of claim 7, wherein the neutralizing agent is a natural limestone mass.

11. The oxidation pond of claim 7, wherein the neutralizing agent comprises limestone fine powders and a binder forming the limestone fine powders into one mass, wherein the binder is dissolved in the mine drainage while the limestone fine powders come in contact with the mine drainage.

12. The oxidation pond of claim 7, wherein the neutralizing agent is a limestone mass having a number of cracks formed by pressing.

13. The oxidation pond of claim 7, wherein the neutralizing agent is any one selected from among a natural limestone mass, a limestone stone having a plurality of cracks formed by pressing, and a form comprising limestone fine powders and a binder forming the limestone fine powders into one mass wherein the binder is dissolved in the mine drainage while the limestone fine powders come in contact with the mine drainage, and wherein the neutralizing agent is suspended in water of the retention pond.

14. The oxidation pond of claim 13, wherein a support is provided on the main baffles, and the neutralizing agent is suspended on the support by a connection element and is disposed in water of the retention pond.

15. The oxidation pond of claim 7, wherein the neutralizing agent is disposed closer to the inlet than the outlet.
